(19) United States
(12) Patent Application Publication
(10) Pub. No.: US 2006/0218566 A1
(43) Pub. Date: Sep. 28, 2006

(54) Combination of disc carrtridge and disc drive

(75) Inventor: Timothy J. Philpot, Havant (GB)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/555,020

(22) PCT Filed: Apr. 20, 2004
(86) PCT No.: PCT/IB04/01315

§ 371 Date: Oct. 31, 2005

(30) Foreign Application Priority Data
May 3, 2003 (GB) 0310272.0

(51) Int. Cl. G11B 17/04; G11B 5/016

(52) U.S. Cl. 720/630; 360/99.02

(57) ABSTRACT

A combination of a disc cartridge and a corresponding disc drive (102), the disc cartridge comprising a casing (108) and a disc shaped media (110) accommodated therein, wherein, during loading and/or unloading the disc cartridge into and/or from the disc drive, a portion (112) of the casing is deformed.

This invention relates to a combination of disc cartridge and disc drive and in particular to where a portion of the disc cartridge is deformable.

It is well known to have removable media, for example floppy discs for use in PCs and the like. The storage needs for compact mobile products, such as PDAs, mobile phones, digital cameras and the like is increasing, for example to support multimedia applications. Contemporary storage technologies provide data densities which permit small form factor disc media formats; for a given data capacity, such media formats can offer lower cost than equivalent solid state storage.

There is a need to minimise the physical volume required for corresponding drives for small form factor disc media. Loading and unloading disc cartridges into a disc drive unit requires a relative movement of the disc and drive unit in a direction perpendicular to the plane of the disc, for example to engage the drive turntable and pick-up unit. Traditionally, this relative movement has been provided by a loading and unloading mechanism. A disadvantage is that the dimensions of the drive unit must be sufficient to accommodate the required relative movement and the associated mechanism. A further disadvantage is that a loading and unloading mechanism has a corresponding cost, which may be exacerbated by implementation within physically compact drive units utilising small moving parts. A yet further disadvantage is that unloading of the disc requires a specific disengagement operation comprising a reversed relative movement in the direction perpendicular to the plane of the disc.

It is an object of the present invention to improve on the known art.

In accordance with the present invention there is provided a combination of a disc cartridge and a corresponding disc drive, the disc cartridge comprising a casing and a disc shaped media accommodated therein, wherein, during loading and/or unloading the disc cartridge into and/or from the disc drive, a portion of the casing is deformed.

Preferably, in the state where the disc cartridge is fully loaded in the disc drive, the casing is not deformed. For example, this allows the disc cartridge, when fully loaded into the drive, to function in conventional fashion.

Optionally, in the state where the disc cartridge is fully loaded in the disc drive, a portion of the casing is deformed. For example, the deformation provides an interference fit between the casing and the disc drive so as to restrain the disc cartridge within the disc drive.

Advantageously, during loading and/or unloading the deformation enables the disc cartridge to pass a protuberance, for example part of a turntable and/or part of a pick-up unit. This avoids the need for separate means in the drive unit to provide the relative movement of the disc and drive unit in a direction perpendicular to the plane of the disc, for example to engage the drive turntable and/or pick-up unit. This in turn means less physical volume is required for the disc drive mechanism. A further advantage is where during unloading the deformation enables the disc cartridge to pass a protuberance, this permits simple unloading techniques, such as manually gripping and withdrawing the cartridge from the drive unit without any prior operation, for example to prior disengage the turntable and/or pick-up unit.

Further provided in accordance with the present invention is the disc cartridge of claim 8 and disc drive as claimed in claim 9.

The present invention will now be described, by way of example only, with reference to the accompanying figures in which:

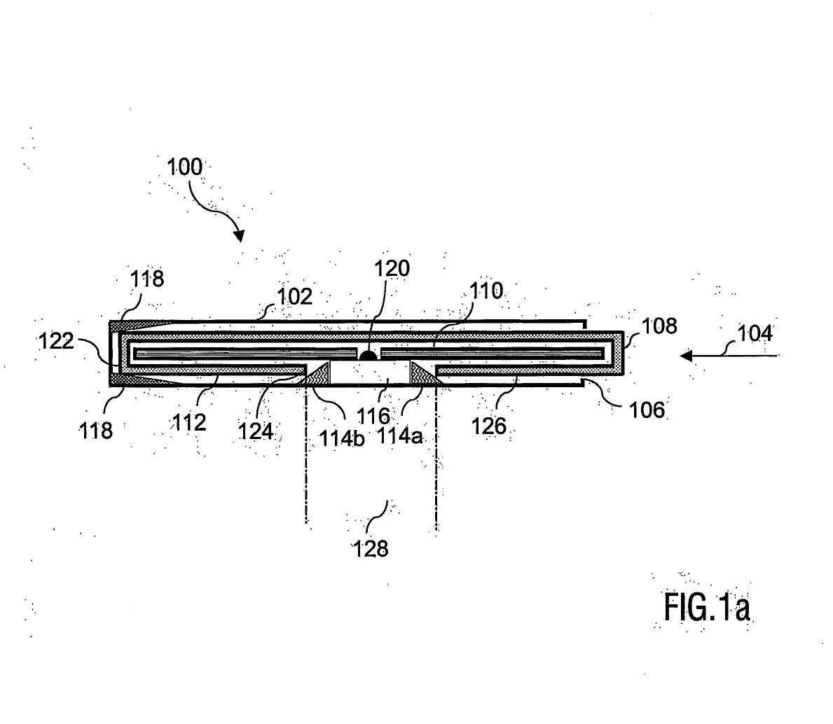

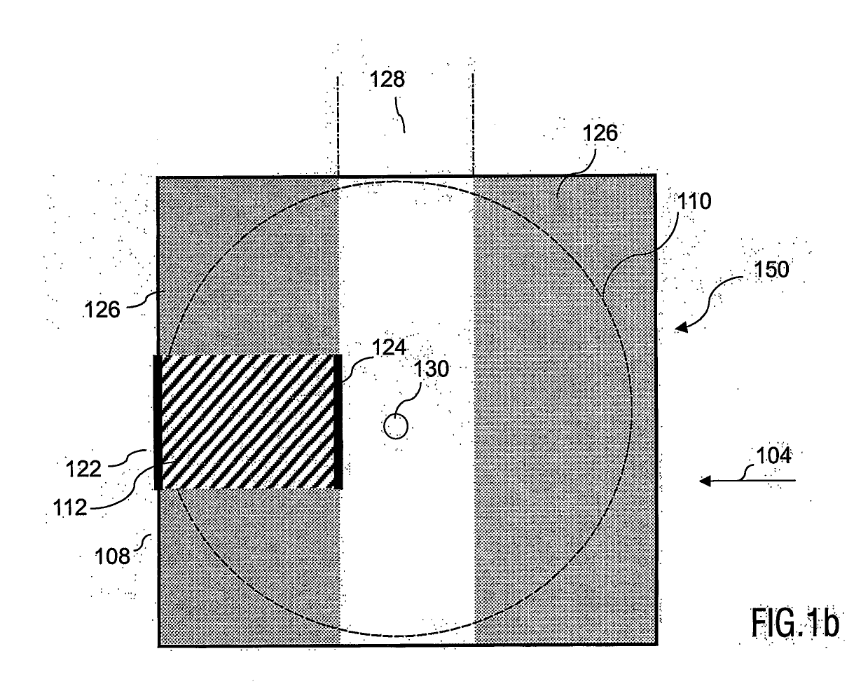

FIG. 1a shows, schematically, an embodiment comprising a combination of a disc cartridge and a corresponding disc drive; and

FIG. 1b shows, schematically, the disc cartridge of FIG. 1a.

FIG. 1a depicts, schematically (and not to scale), an embodiment comprising a combination of a disc cartridge and a corresponding disc drive shown generally at 100. The disc cartridge comprises a casing 108 and a disc shaped media 110 accommodated therein. The cartridge is loaded in direction 104 into disc drive 102 through an aperture 106 of the disc drive. A portion 112 of the casing of the cartridge is deformable.

During loading of the cartridge to the disc drive the leading edge 122 of portion 112 encounters bevelled edge 114a which acts to deform portion 112 to enable the cartridge to pass turntable 116. The deformation may also enable the cartridge to pass a pick-up unit (not shown in FIG. 1a). Turntable 116 also comprises a sprung loaded spigot 120 which is depressed by portion 112 as it passes the turntable.

When the cartridge is fully loaded portion 112 has completed its passage past the turntable such that trailing edge 124 of portion 112 has passed clear of bevelled edge 114b. The planar side 126 of the casing 108 of which portion 112 forms a part has an aperture 128 suitable to accommodate the turntable 116 and bevelled edges 114a and 114b. Aperture 128 may be revealed during loading by moving a shutter (for clarity, not shown in FIG. 1a). The co-operation of turntable and bevelled edges with the aperture may adequately restrain the disc cartridge within the disc drive. Optionally, the leading edge 122 is also deformed by co-operation of the casing with portions 118 within the disc drive 102 thereby providing an interference fit between the casing and the disc drive so as to restrain the disc cartridge within the disc drive. When the cartridge is fully loaded sprung loaded spigot 120 is no longer depressed by portion 112 and instead engages in an aperture of the disc shaped media 110 for example to align the media in relation to the turntable, in preparation for accessing the disc by a pick-up unit (not shown in FIG. 1a).

During the unloading of the cartridge from the disc drive unit the trailing edge 124 of portion 112 encounters bevelled edge 114b which acts to deform portion 112 so as to pass turntable 116. As in the loading process, sprung loaded spigot 120 is depressed by portion 112 as it passes the turntable. During unloading, portion 112 is no longer deformed once its leading edge 122 has passed clear of bevelled edge 114a.

FIG. 1b depicts, schematically (and not to scale), the disc cartridge of FIG. 1a, shown generally at 150. The disc cartridge comprises the casing 108 and disc shaped media 110 (with drive hole 130) accommodated therein. A planar side 126 of the casing 108 has an aperture 128 suitable to accommodate the turntable 116 and bevelled edges 114a and 114b, as discussed above in relation to FIG. 1a. The aperture may be exposed by a shutter arrangement (not shown in FIG. 1b). Side 126 also comprises deformable portion 112 comprising a leading edge 122 (denoted according to the loading direction 104 of the disc into the disc drive) and a trailing edge 124. Portions 118 within the disc drive 102 may be arranged to interfere at any point or points along the leading edge 122; alternatively, another deformable portion of the casing may be used to provide an interference fit with the disc drive so as to restrain the disc cartridge within the disc drive. In other embodiments, the leading and/or trailing edge of the deformable portion 112 may be arcuate or other suitable profile. The deformable portion of the casing 108 may be arranged according to the needs of a particular embodiment and may comprise one or more portions, each portion may extend further than actually required for a particular corresponding disc drive.

The foregoing implementations are presented by way of example only and represent a selection of a range of implementations that can readily be identified by a person skilled in the art to exploit the advantages of the present invention. Disc cartridges other than those which are rectangular can also embody the invention, for example a disc cartridge wherein one or more edges are arcuate.

In the description above and with reference to FIG. 1a there is disclosed a combination of a disc cartridge and a corresponding disc drive 102, the disc cartridge comprising a casing 108 and a disc shaped media 110 accommodated therein, wherein, during loading and/or unloading the disc cartridge into and/or from the disc drive, a portion 112 of the casing is deformed.

1. A combination of a disc cartridge and a corresponding disc drive (102), the disc cartridge comprising a casing (108) and a disc shaped media (110) accommodated therein, wherein, during loading and/or unloading the disc cartridge into and/or from the disc drive, a portion (112) of the casing is deformed.

2. A combination of a disc cartridge and a corresponding disc drive as claimed in claim 1, wherein, in the state where the disc cartridge is fully loaded in the disc drive, the casing is not deformed.

3. A combination of a disc cartridge and a corresponding disc drive as claimed in claim 1, wherein, in the state where the disc cartridge is fully loaded in the disc drive, a portion of the casing is deformed.

4. A combination of a disc cartridge and a corresponding disc drive as claimed in claim 3, wherein the deformation provides an interference fit between the casing and the disc drive so as to restrain the disc cartridge within the disc drive.

5. A combination of a disc cartridge and a corresponding disc drive as claimed in claim 1, wherein during loading and/or unloading the deformation enables the disc cartridge to pass a protuberance.

6. A combination of a disc cartridge and a corresponding disc drive as claimed in claim 5, wherein the protuberance is at least part of a turntable (116).

7. A combination of a disc cartridge and a corresponding disc drive as claimed in claim 6, wherein the protuberance is at least part of a pick-up unit.

8. A disc cartridge comprising a casing and a disc shaped media accommodated therein, wherein during loading and/or unloading the disc cartridge into and/or from a corresponding disc drive, a portion of the casing is deformed.

9. A disc drive configured to deform a corresponding disc cartridge, comprising a casing and a disc shaped media accommodated therein, during loading and/or unloading of the disc cartridge into and/or from the disc drive.
